(19) United States
(12) Patent Application Publication
(10) Pub. No.: US 2006/0283004 A1
(43) Pub. Date: Dec. 21, 2006

(54) Method of manufacturing stator of rotary electric machine

(75) Inventor: Tooru Ooiwa, Toyota-city (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/415,127

(22) Filed: May 2, 2006

(30) Foreign Application Priority Data
Jun. 16, 2005 (JP) 2005-176421

(51) Int. Cl. H02K 15/00

(52) U.S. Cl. 29/596; 29/606

(57) ABSTRACT

A stator of a rotary electric machine is composed of a cylindrical stator core and stator windings inserted into slots of the stator core. A laminated body is formed by laminating steel sheets having slots and teeth. After stator windings in a flat shape are inserted into slots of the laminated body, the laminated body is bent into a cylindrical form along rollers between which the laminated body is sandwiched. In the bending process, positions of the teeth are restrained to prevent the stator windings disposed in the slots from being damaged by movement of the teeth. Alternatively, a bump extending from each tooth is formed, so that the tooth is restrained by gripping the bump in the bending process. The bumps are removed after completion of the bending process.

### CROSS-REFERENCE TO RELATED APPLICATION

This application is based upon and claims benefit of priority of Japanese Patent Application No. 2005-176421 filed on Jun. 16, 2005, the content of which is incorporated herein by reference.

### BACKGROUND OF THE INVENTION

1. Field of the Invention

The present invention relates to a method of manufacturing a stator of a rotary electric machine such as an automotive alternator.

2. Description of Related Art

JP-A-9-103052 discloses an example of a method of manufacturing a stator of a rotary electric machine. This manufacturing method is composed of following steps: First, elongated sheets are formed by stamping a steel plate, each elongated sheet (about 20 mm wide and about 1 mm thick) having slots and teeth; then, elongated sheets are laminated into a rectangular-solid; then, stator windings in a flat shape are inserted (or disposed) in the slots; and then, the laminated rectangular-solid having the stator windings in its slots is bent into a form of a cylindrical stator, so that the openings of the slots face the inside of the stator; and finally, both ends of the laminated sheets bent in a cylindrical shape are welded.

In this method, however, there is a problem that end portions of the teeth move in the circumferential direction in the bending process, thereby damaging insulation films covering the stator windings disposed in the slots.

### SUMMARY OF THE INVENTION

The present invention has been made in view of the above-mentioned problem, and an object of the present invention is to provide an improved method of manufacturing a stator of a rotary electric machine, in which insulation films of stator windings are prevented from being damaged.

A stator of a rotary electric machine is composed of a cylindrical stator core and stator windings inserted in slots formed in the stator core. The stator is manufactured in the following manner. Elongated sheets having teeth and slots are stamped out from a steel plate. The elongated sheets are laminated, forming a rectangular-solid-shaped laminated body. Stator windings in a flat shape are inserted in the slots, guided by guiding jigs aligned to the teeth. Then, the laminated body with the stator windings is bent into a cylindrical shape along rollers sandwiching the laminated body. Both ends of the laminated body are welded to form a cylindrical stator. Wire ends of the stator windings are electrically connected to form an armature winding.

In the process of bending the laminated body into a cylindrical shape, teeth of the laminated body are restrained not to move in the circumferential direction in order to prevent insulation films covering the stator windings from being damaged by the movement of the teeth. Wedge-shaped projections formed on a roller, along which the laminated body is bent into a cylindrical shape, are inserted in open ends of the slots to thereby maintain a distance between neighboring two teeth. Since the teeth keep their correct positions during the bending process, the stator windings are prevented from being damaged by movement of the teeth.

The tip portion of each tooth may be extended to form a bump which is gripped by a depression formed on the roller, along which the laminated body is bent. In this manner, the teeth can keep their correct positions in the bending process. The bump extended from the tooth may be in a rectangular shape, so that neighboring bumps contact each other when the laminated body is bent into the cylindrical shape. The movement of the teeth in the circumferential direction in the bending process is surely prevented in this manner. The bumps formed for restraining movement of the teeth are removed by a rotating cutter after completion of the bending process.

In the process of removing the bumps, jigs for restraining movement of the teeth are inserted into open ends of the slots. Alternatively, teeth are pressed from both axial ends of the laminated sheets to restrain movement of the teeth due to a cutting force of the rotating cutter. The stator windings inserted into the slots of the stator core may be molded together with the stator core with resin before the process of removing the bumps. In this manner, the teeth are securely restrained.

According to the present invention, the stator windings inserted into the slots of the laminated body are surely prevented from being damaged by the movement of the teeth in the bending process. Other objects and features of the present invention will become more readily apparent from a better understanding of the preferred embodiment described below with reference to the following drawings.

### BRIEF DESCRIPTION OF THE DRAWINGS

FIG. 1 is a cross-sectional view showing an automotive alternator to which the present invention is applied;

FIG. 2 is a perspective view showing a stator of the automotive alternator;

FIG. 3 is a flowchart showing a process of manufacturing a stator;

FIG. 4 is a plan view showing an elongated sheet stamped out of a steel plate;

FIG. 5 is a perspective view showing a laminated body for a stator core;

FIG. 6 is a perspective view showing a process of inserting stator windings in a flat shape into slots of the laminated body;

FIG. 7 is a schematic view showing a process of inserting stator windings into slots of a stator;

FIG. 8 is a schematic view showing a process of bending the laminated body into a cylindrical shape;

FIG. 9 is a plan view showing an inner rotor engaging with slots of the stator core in a process of bending the laminated body;

FIG. 10 is a plan view showing teeth of an elongated sheet, each tooth having a bump formed at its tip portion;

FIG. 11 is a plan view showing an inner rotor engaging with the bumps of the teeth;

FIG. 12 is a plan view showing another example of the bumps formed at the tips of the teeth;

FIG. 13 is a plan view showing the laminated body after it is bent into a cylindrical shape;

FIG. 14 is a schematic view showing a process of cutting off the bumps after the laminated body is bent into a cylindrical shape, while restraining movement of the teeth in the circumferential direction;

FIG. 15 is another example showing a way of restraining movement of the teeth in the circumferential direction; and

FIG. 16 is yet another example showing a way of restraining movement of the teeth in the circumferential direction.

### DETAILED DESCRIPTION OF THE PREFERRED EMBODIMENT

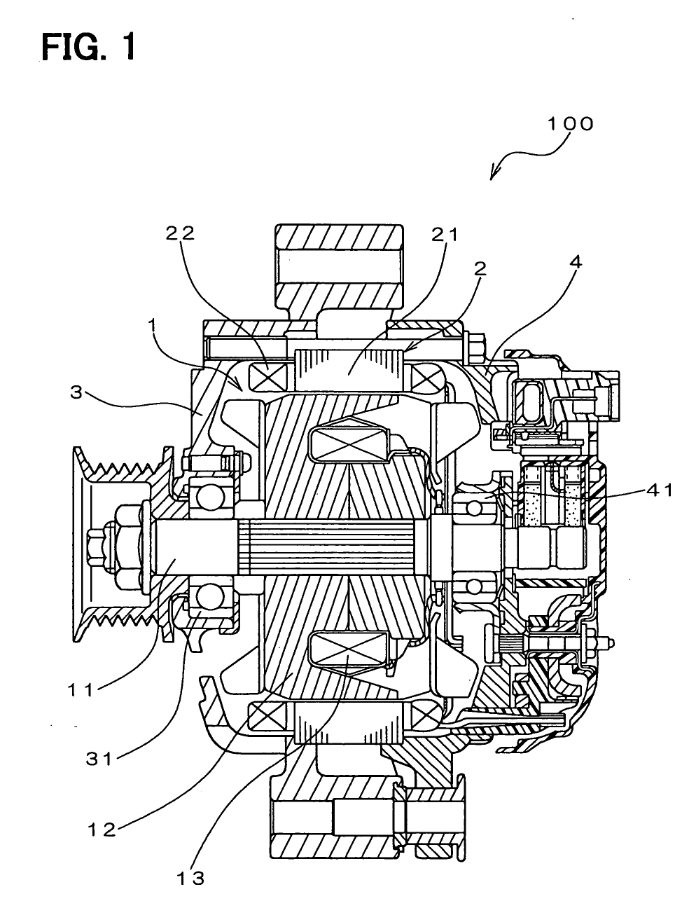

A preferred embodiment of the present invention will be described with reference to accompanying drawings. FIG. 1 shows an alternator (AC generator) for use in an automotive vehicle, to which the present invention is applied. The alternator 100 includes a rotor 1, a stator 2, a front bracket 3 and a rear bracket 4. The rotor 1 is composed of a rotor shaft 11, a pair of claw-shaped field cores 12 fixed to the rotor shaft 11, and a field winding 13 wound on the field cores 12. The stator 2 having a stator core 21 and stator windings 22 disposed in the stator core is positioned around the rotor 1 with a certain air gap therebetween. The stator 2 is sandwiched between the front bracket 3 and the rear bracket 4. The rotor 1 is rotatably supported by bearings 31, 41 held in the front bracket 3 and the rear bracket 4, respectively.

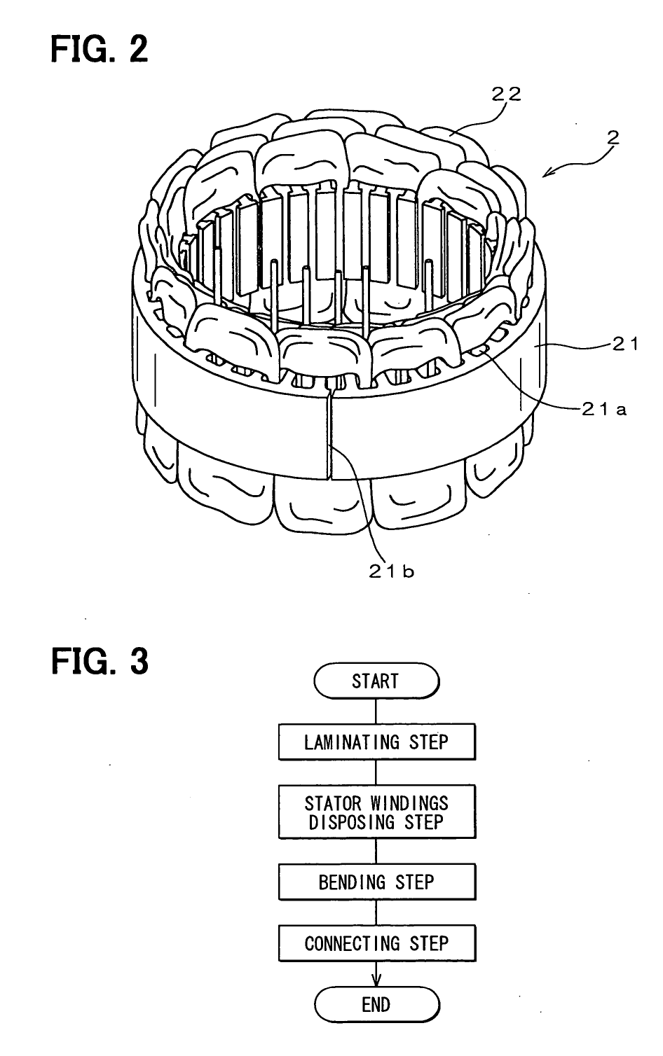

FIG. 2 shows an example of the stator 2 used in the alternator 100. The stator 2 is composed of a cylindrical stator core 21 and stator windings 22 held in slots 21a formed in the stator core 21. The cylindrical stator core 21 is formed from a rectangular-solid laminated body in a manner described below, and both ends of the laminated body are welded at a welded portion 21b.

Now, a method of manufacturing the stator 2 will be described. In FIG. 3 steps of the manufacturing method are shown. First, elongated steel sheets are laminated, forming a rectangular-solid laminated body 20 (laminating step). Then, stator windings 22 are inserted into slots 21a of the laminated body 20 (stator windings disposing step). Then, the laminated body having the stator windings therein is bent into a cylindrical shape (bending step). Then, wire ends of the stator windings 22 are electrically connected to form an armature winding.

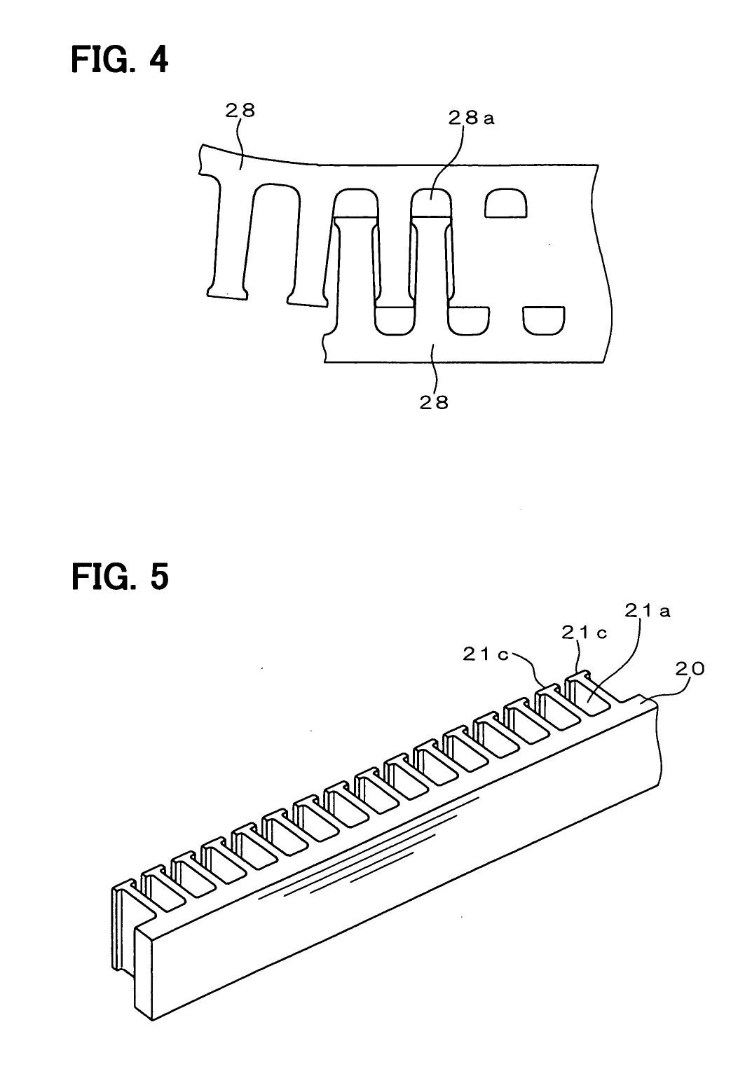

With reference to FIGS. 4-9, the steps of the manufacturing method will be described in detail. As shown in FIG. 4, the elongated steel sheet 28 (e.g., 0.5 mm thick, 20 mm wide and in a predetermined length) is stamped out from a steel plate such as a silicon steel plate. Plural elongated sheets 28 are laminated to form a rectangular-solid laminated body 20 shown in FIG. 5. The laminated body 20 has slots 21a and teeth 21c forming the slots therebetween.

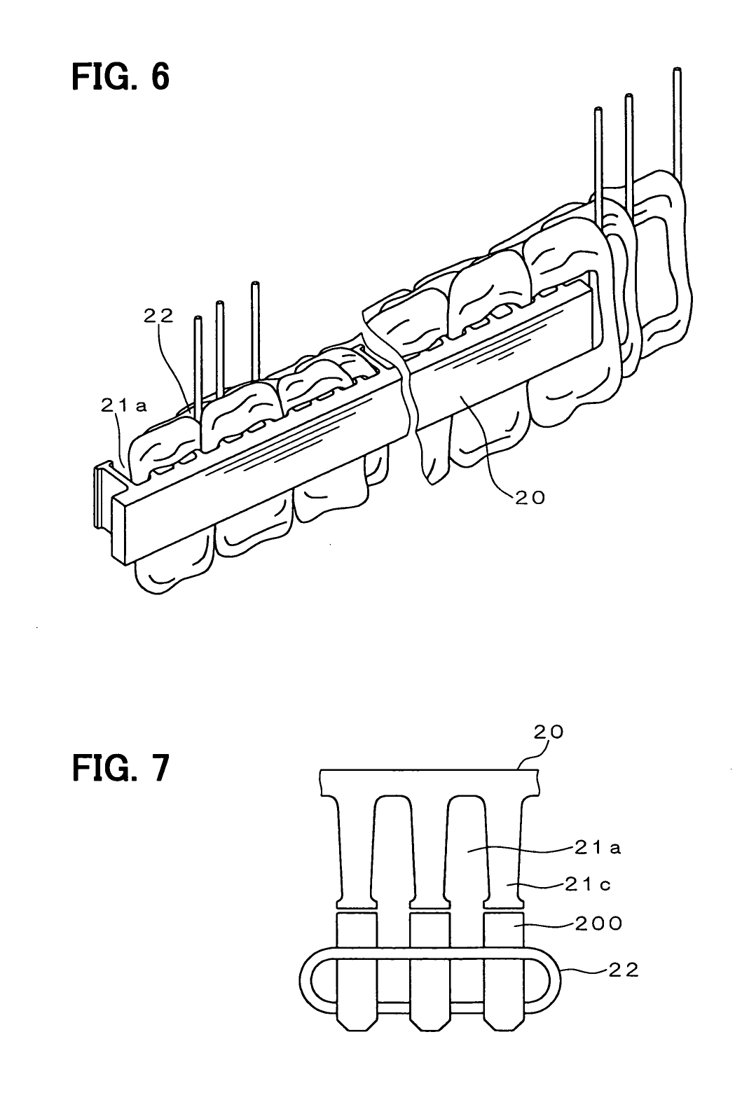

The stator windings 22 are formed in a flat shape so that they are easily inserted into the slots 21a of the laminated body 20. As shown in FIG. 6, the flattened stator windings 22 are inserted into the slots 21a. For example, the stator windings may be inserted into the slots in a way as shown in FIG. 7. Guiding jigs 200 are aligned to each tooth 21c, and the stator winding 22 is positioned in the slots 21a, guided by the guiding jigs 200. The guiding jigs 200 are the same jigs which are used in a process of making the stator windings 22 in a flat shape.

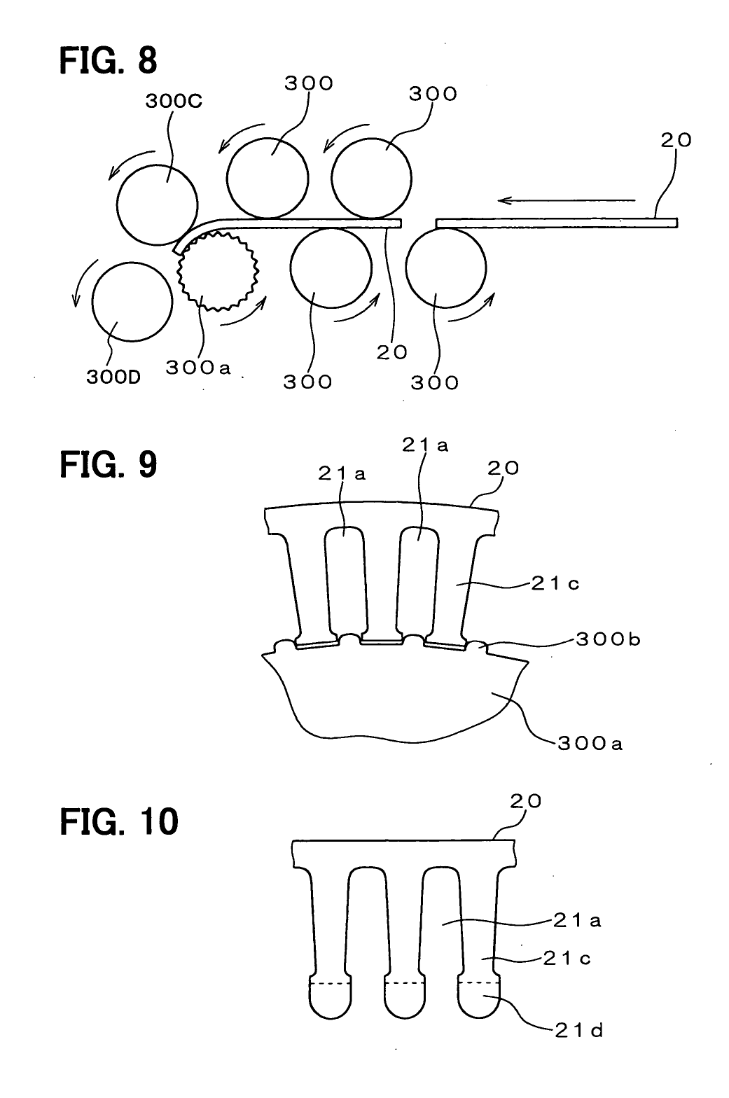

Then, the laminated body 20 including the stator windings 22 inserted therein is bent into a cylindrical shape, as shown in FIG. 8. The laminated body 20 is sandwiched between plural rollers 300 from its outside and inside. The laminated body 20 is gradually bent by the plural rollers 300, 300C, 300D, so that it becomes a cylindrical shape along surfaces of the rollers. The rollers 300C, 300D are positioned along a bending radius of the laminated body 20. As shown in FIG. 9, the inner roller 300a at the final stage has wedge-shaped projections 300b that engage with the slot 21a between teeth 21c.

Since the wedge-shaped projection 300b is positioned between a pair of teeth 21c in the bending process, a distance between the neighboring teeth 21c is maintained at a predetermined distance. In this manner, the tips of the teeth 21c are prevented from moving in the circumferential direction in the bending process. The width of the wedge-shaped projection 300b is made substantially equal to a final distance between neighboring teeth 21c. The height of the projection 300b is made not to contact the stator windings 22 disposed in the slots 21a. Since the positions of teeth 21c are correctly kept in the bending process, the stator windings 22 disposed in the slots 21c are not damaged by the teeth 21c.

Advantages attained in the embodiment described above will be summarized below. Since the laminated body 20 is bent into a cylindrical shape after the stator windings 22 are inserted into the slots 21a of the laminated body 20, both of the stator core 21 and the stator windings 22 are formed into a final shape at the same time. Since the teeth 21c are prevented from moving in the circumferential direction in the bending step, insulation films of the stator windings 22 are not damaged by the teeth 21c.

Since the stator windings 22 are guided by the guiding jigs 200 when they are inserted into the slots 21a of the laminated body 20, the stator windings 22 are smoothly positioned in the slots 21a without being damaged. Further, since the same jigs that are used in forming the stator windings 22 in a flat shape are used as the guiding jigs 200 without taking out of the stator windings 22, the manufacturing steps are simplified.

It is possible to use a pair of end sheets, which are thicker than other sheets, at both axial ends of the laminated body 20 to prevent deformation of the teeth 21c. However, this is not economical because two kinks of steel sheets have to be prepared. Moreover, eddy current loss in the stator core 21 will become higher when thicker sheets are used. Therefore, it is usual to use one kind of sheet having a thickness of 0.35-0.5 mm.

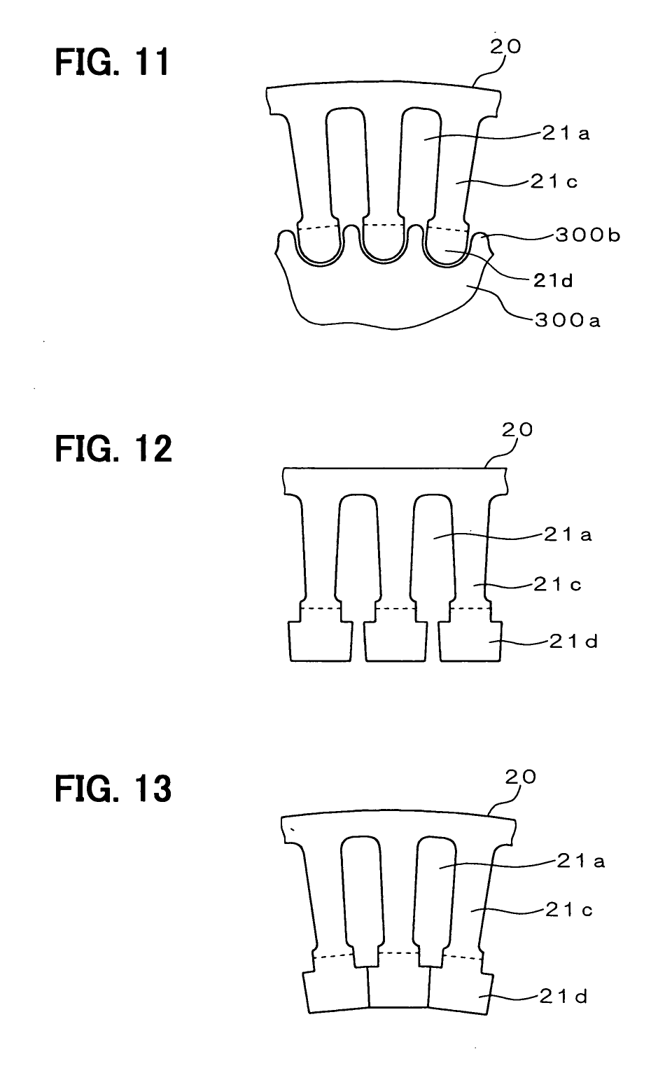

The embodiment described above may be modified to a form shown in FIGS. 10 and 11. In this modified form, a bump 21d in a semi-circular shape is additionally formed integrally with each tooth 21c, as shown in FIG. 10. The mechanical strength of the tooth 21c is improved by the bump 21d. A portion 28a (shown in FIG. 4) to be punched out from a steel plate by stamping can be utilized as the bump 21d. In this manner, a portion wasted in the steel plate can be effectively utilized.

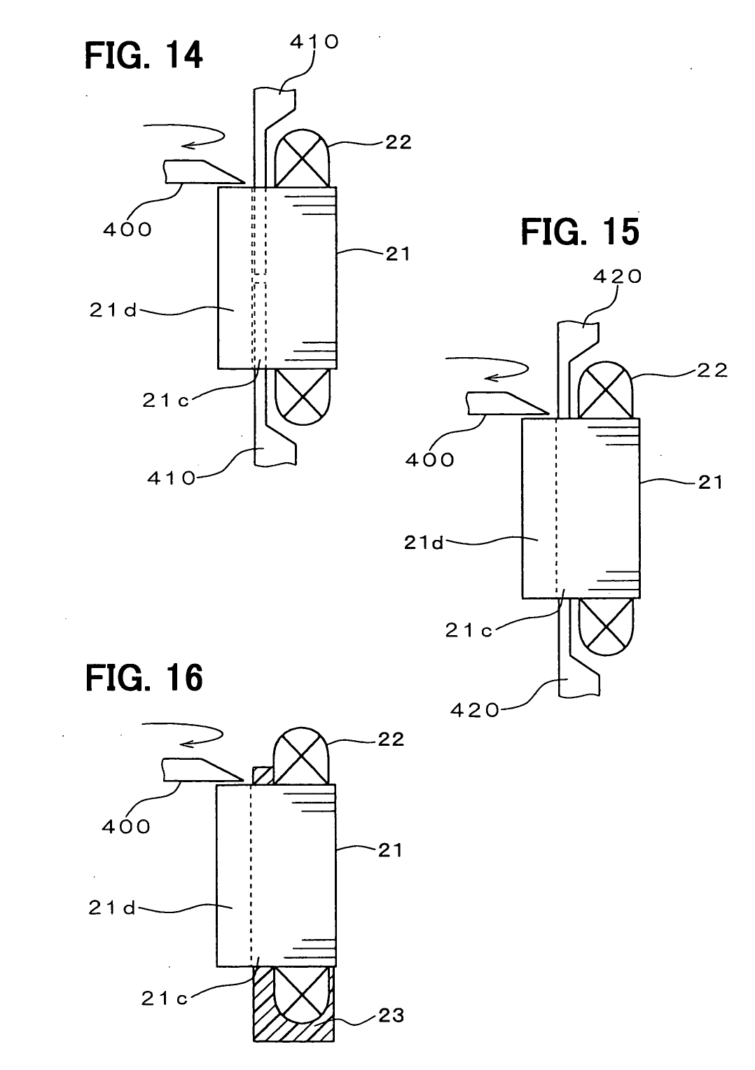

As shown in FIG. 11, an inner roller 300a having depressions engaging with the bumps 21d is provided, and the bumps 21d are accommodated in the depressions in the bending process. In this case, the wedge-shaped projection 300b can be made larger compared with that shown in FIG. 9. Therefore, the teeth 21c are securely held not to move in the circumferential direction in the bending process. Accordingly, the stator windings 22 are surely prevented from being damaged by the teeth 21c in the bending process. Then bumps 21d are cut off after the bending process is completed in the manner explained later with reference to FIGS. 14-16.

The bump 21d may be formed in a shape that gradually becomes narrower as it becomes farther from the tip portion of the tooth 21c (not shown in drawings). In other words, the bump 21d may be shaped in a triangular shape extending from the tip of the tooth 21c. In this case, the triangular bump 21d may be used as the guiding jig in the process of inserting stator windings 22 into the slots 21a.

The bump 21d may be modified to a form shown in FIGS. 12 and 13. In this modified form, the bump 21d is formed in a rectangular shape as shown in FIG. 12. When the laminated body 20 is bent into a cylindrical shape, the neighboring bumps 21d closely contact each other, as shown in FIG. 13. In this case, the stator windings 22 disposed in the slots 21a are prevented from being damaged without restraining the teeth 21c in the bending process.

The bumps 21d formed integrally with the teeth 21c have to be removed after the laminated body 20 is bent into a cylindrical shape. In order to minimize stress imposed on the teeth 21c or the stator windings 22 in the process of removing bumps 21d, the bumps 21d are cut off by machining, as shown in FIGS. 14-16. In FIG. 14, the bumps 21d are cut off by a rotating cutter 400, while teeth 21c are restrained by restraining jigs 410 inserted into an open end of each slot 21a. Movement of the teeth 21c in the circumferential direction due to the cutting force of the rotating cutter 400 is prevented by the restraining jigs 410, and thereby the stator windings 22 are prevented from being damaged.

FIG. 15 shows another example of restraining the teeth 21c in the process of removing the bumps 21d. In this example, too, the bumps 21d are cut off by a rotating cutter 400. In the removing process, the cylindrical stator core 21 is pushed in the axial direction with a pair of cylindrical restraining jigs 420. In other words, the laminated stator core 21 is pushed in the compressing direction from both axial ends to restrain movement of the teeth 21c in the circumferential direction due to the cutting force.

FIG. 16 shows yet another example of restraining the teeth 21c in the process of removing the bumps 21d. In this example, the cylindrical stator core 21 having the stator windings 22 therein is molded with resin 23 before the process of removing the bumps by the rotating cutter 400. In other words, one coil end and open end portions of the slots 21a are molded with resin 23, as shown in FIG. 16. Since the stator windings 22 and the stator core 21 are integrally connected with the molded resin 23 in this example, the teeth 21c are firmly restrained, and the stator windings 22 are protected from cutting force generated by the rotating cutters 400. The stator core 21 may be rotated against a fixed cutter, if the stator core 21 is easily held by a chuck.

The present invention is not limited to the embodiment described above, but it may be variously modified. For example, the present invention may be applied to rotary electric machines other than the automotive alternator. A slot-pitch, or a circumferential distance between neighboring two slots may not be uniform in case it is necessary to change the number of conductors in certain slots. The movement of the teeth in the bending process can be prevented in this case, too, according to the present invention. In the case where a wider tooth and a thinner tooth are alternately positioned, it would be sufficient if only the wider teeth are restrained in the bending process. In the case where eddy current loss has to be further reduced, a thinner steel sheet, such as 0.35 mm thick, may be used in place of the steel sheet having a thickness of 0.5 mm. The advantage of the present invention is prominent in this case.

While the present invention has been shown and described with reference to the foregoing preferred embodiment, it will be apparent to those skilled in the art that changes in form and detail may be made therein without departing from the scope of the invention as defined in the appended claims.

What is claimed is:

1. A method of manufacturing a stator of a rotary electric machine, the method comprising steps of:
laminating elongated sheets to form a rectangular-solid-shaped laminated body having a plurality of slots;
inserting stator windings in the slots; and
bending the laminated body into a cylindrical stator, wherein:
in the bending step, teeth forming the slots are restrained not to move in the circumferential direction of the cylindrical stator.

2. The manufacturing method as in claim 1, wherein:
the stator windings are formed in a flat shape before inserting in the slots; and
at least part of wire ends of the stator windings is electrically connected after the laminated body is bent into the cylindrical stator.

3. The manufacturing method as in claim 1, wherein:
the teeth are restrained in the bending step by inserting wedge-shaped projections in open ends of the slots.

4. The manufacturing method as in claim 1, wherein:
the teeth are restrained in the bending step by restraining bumps formed on a tip of each tooth integrally therewith.

5. The manufacturing method as in claim 4, wherein:
the bump contacts the neighboring bump after the laminated body is bent into the cylindrical stator.

6. The manufacturing method as in claim 4, wherein:
the bumps are removed by machining while the teeth are restrained not to move in the circumferential direction of the cylindrical stator.

7. The manufacturing method as in claim 6, wherein:
the teeth are restrained by inserting restraining jigs into open ends of the slots.

8. The manufacturing method as in claim 6, wherein:
the teeth are restrained by pressing the teeth from both axial ends of the cylindrical stator.

9. The manufacturing method as in claim 6, wherein:
the teeth are restrained by molding spaces between teeth with resin.

10. The manufacturing method as in claim 2, wherein:
the stator windings in a flat shape are inserted into the slots, guided by guiding jigs aligned to the teeth.

11. The manufacturing method as in claim 10, wherein:
the guiding jigs are commonly used as jigs for forming the stator windings in a flat shape.

12. The manufacturing method as in claim 10, wherein:
the guiding jigs are formed integrally with the teeth to extend from the teeth, each guiding jig being in a triangular shape gradually becoming narrower from its foot connected to the tooth toward a tip of the guiding jig.

13. The manufacturing method as in claim 1, wherein:
at least one slot pitch is different from a neighboring slot pitch.

14. The manufacturing method as in claim 3, wherein:
the wedge-shaped projections are formed on a roller, along which the laminated body is bent into a cylindrical shape.
